(19) United States
(12) Patent Application Publication
(10) Pub. No.: US 2022/0207552 A1
(43) Pub. Date: Jun. 30, 2022

(54) SYSTEM AND METHOD TO DETERMINE ENVIRONMENTAL EMISSIONS AND FOOTPRINTS BASED ON FINANCIAL DATA

(71) Applicant: Offspend SAS, Paris (FR)

(72) Inventors: Alexis Normand, Paris (FR); Matthieu Vegreville, Sevrier (FR); Paul de Kerret, NICE (FR)

(21) Appl. No.: 17/136,443

(22) Filed: Dec. 29, 2020

(51) Int. Cl. G06Q 30/02; G06Q 30/06; G06Q 20/38

(52) U.S. Cl. CPC G06Q 30/0211; G06Q 30/0215; G06Q 20/389; G06Q 30/0607; G06Q 30/0631

(57) ABSTRACT

A system to determine environmental emission and footprints is provided. The system includes a data acquisition module to acquire financial transaction data associated with an individual or an organization. The system includes a classification module to classify the financial transaction data by labelling/sub-labelling into categories of services and products. The system includes an emission computation module to compute a rate of emission avoided per transaction based on purchase of a product or service with less carbon emission than the predefined category of product or service with higher carbon emission, carbon emissions are computed based on a predefined emission factor of the predefined category of product or service. The system includes an environmental footprint computation module to compute environmental footprints per transaction using machine learning trained based on the classification of the financial transaction data into a predefined category of product and service and the rate of emission avoided per transaction.

### FIELD OF INVENTION

Embodiments of the present disclosure relates to consumption management and more particularly to a system and a method to determine environmental emission and footprints based on financial data.

### BACKGROUND

Consumer transactions involve a provider and a consumer of a desired goods or service. Primary factors in purchasing decision typically include price, convenience, and quality of the desired good or service. Traditionally, these factors are readily available to consumers. As such, they tend to be the driving factors in determining whether to proceed with the transaction. However, in the collective, such transactions can produce wide range of consequences, often unintended by the consumer and the provider. For example, to be competitive on the factors of price, convenience, and quality, businesses can be less attentive to other concerns, such as environmental impact and societal impact.

Environmental impact includes metrics such as CO2 emission, renewable power usage, waste disposal, resource efficiency, use of land, water consumption, recycling, just to name a few. Societal impact can include issues such as compliance with child labor laws, fair labor practices, healthcare coverage, compensation issues, and others. Such environmental and societal concerns are important to many individuals. Individuals intending to affect change in these areas of concern typically do so through various channels such as political activism, charitable donations, volunteerism, or their profession. However, due in part to a lack of information, it can be challenging for individuals to align their everyday purchasing decisions with such concerns. Individuals that endeavor to conform their purchasing decisions to be in line with their societal and environmental values often require substantial investments of time and resources. As such, only very dedicated individuals, endowed with the necessary time and resources, can successfully conform their purchasing habits to their environmental and societal concerns. Likewise, companies have limited information as to the environmental impact of their purchases of goods and services in everyday operational activities and lack a systematic measure of how their activities impact such as climate change.

To minimize environmental impacts with higher efficiency and drive stakeholder engagement, it is important to measure the environmental impact of activities of given organizations and generate widespread awareness as to where improvement areas can reside. For example, it is necessary to obtain the environmental impacts, and particularly the carbon footprint throughout the complete life cycle of products, using the idea of Eco-Balance. Conventional systems are unable to accurately obtain the environmental impacts in the life cycle of products. Thus, in many cases, actions aimed at fighting damages to the environment, and particularly at curbing carbon intensive activities that accelerate climate change are done on the impulse or by individuals who personally care about the environment at the organization, taking great length to measure their impact with manual computation. When it comes to allocating financial resources to protect the environment or to curb climate change, there is only a limited amount of information available regarding organizations and how purchasing from them or contributing to their capital or turnover impacts the planet. At present, the true cost of an economic activity on the environment and particularly the way that it affects climate change is typically not reflected in the financial analysis of a given good or organization. Hence, it cannot be objectively analyzed. Therefore, while promoting environmental conservation activities and actions that contribute to the lowering of carbon emissions and the fight against climate change, consumers and organizations alike lack information to determine how to allocate their spending or investments between different sets of activities.

Hence, there is a need for an improved system and method to determine environmental emission and carbon footprints to address the aforementioned issue(s).

### BRIEF DESCRIPTION

In accordance with an embodiment of the present disclosure, a system to determine environmental emissions and footprints is provided. The system includes a processing subsystem hosted on a server and configured to execute on a network to control bidirectional communications among a plurality of modules. The processing subsystem includes a data acquisition module configured to acquire financial transaction data associated with an individual or an organization through a financial institution based software. The processing subsystem also includes a classification module configured to classify the financial transaction data acquired by the data acquisition module by labelling and sub-labelling into a plurality of categories of services and products. The processing subsystem includes an emission computation module configured to compute a rate of emission avoided per transaction based on purchase of a product or service with less carbon emission than the predefined category of product or service with higher carbon emission, wherein carbon emissions are computed based on a predefined emission factor of the predefined category of product or service classified by the classification module. The processing subsystem further includes an environmental footprint computation module configured to compute environment footprints per transaction using a machine learning model trained based on the classification of the financial transaction data into a predefined category of product and service and the rate of emission avoided per transaction computed by the emission computation module. The environmental footprints computation module is also configured to compute environmental footprints corresponding to the individual by aggregating environmental footprints per transactions associated with the individual. The environmental footprints computation module is further configured to compute environmental footprints corresponding to the organization by aggregating environmental footprints per transactions associated with the organization. The processing subsystem further includes a score computation module configured to compute an environmental score associated with the organization based on the predefined emission factor as a function of a rank of the organization and the environmental footprints computed by the environmental footprint computation module. The score computation module is also configured to compute an environment score associated with the individual using a profile information to adapt estimation of the emission factor using a plurality of criterion impacting the rate of emission and the environmental footprints computed by the environmental footprints computation module.

In accordance with another embodiment of the present disclosure, a method to determine environmental emissions and footprints is provided. The method includes acquiring, by a data acquisition module, financial transaction data associated with an individual or an organization through a financial institution based software. The method also includes classifying, by a classification module, the financial transaction data acquired by the data acquisition module by labelling and sub-labelling into a plurality of categories of services and products. The method further includes computing, by an emission computation module, a rate of emission avoided per transaction based on purchase of a product or service with less carbon emission than the predefined category of product or service with higher carbon emission, wherein carbon emissions are computed based on a predefined emission factor of the predefined category of product or service classified by the classification module. The method further includes computing, by an environmental footprints computation module, environment footprints per transaction using a machine learning model trained based on the classification of the financial transaction data into a predefined category of product and service and the rate of emission avoided per transaction computed by the emission computation module. The method further includes computing, by the environmental footprint computation module, environmental footprints corresponding to the individual by aggregating environmental footprints per transactions associated with the individual. The method further includes computing, by the environmental footprint computation module, environmental footprints corresponding to the organization by aggregating environmental footprints per transactions associated with the organization. The method further includes computing, by a score computation module, an environmental score associated with the organization based on the predefined emission factor as a function of a rank of the organization and the environmental footprints computed by the environmental footprint computation module. The method further includes computing, by the score computation module, an environment score associated with the individual using a profile information to adapt estimation of the predefined emission factor using a plurality of criterion impacting the rate of emission and the environmental footprints computed by the environmental footprints computation module.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of system to determine environmental emission and footprints in accordance with an embodiment of the present disclosure;

FIG. 2 is a schematic representation of one embodiment of the system of FIG. 1, depicting categorization steps in accordance with an embodiment of the present disclosure;

FIG. 3 is a schematic representation of another embodiment of the system of FIG. 1, depicting emission computation in accordance with an embodiment of the present disclosure;

FIG. 4 is a block diagram representation of one embodiment of the system of FIG. 1 in accordance with an embodiment of the present disclosure;

FIG. 5 is a schematic representation of an exemplary system of FIG. 1 in accordance with an embodiment of the present disclosure;

FIGS. 5(a) and 5(b) illustrates schematic representation of one embodiment of the exemplary system of FIG. 5 in accordance with an embodiment of the present disclosure;

FIG. 6 is a block diagram of a computer or a server for system in accordance with an embodiment of the present disclosure; and

FIGS. 7(a) and 7(b) illustrates a flow chart representing the steps involved in a method to determine environmental emission and footprints based on financial data in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method to determine environmental emission and footprints is provided. The system includes a processing subsystem hosted on a server and configured to execute on a network to control bidirectional communications among a plurality of modules. The processing subsystem includes a data acquisition module configured to acquire financial transaction data associated with an individual or an organization through a financial institution based software. The processing subsystem also includes a classification module configured to classify the financial transaction data acquired by the data acquisition module by labelling and sub-labelling into a plurality of categories of services and products. The processing subsystem includes an emission computation module configured to compute a rate of emission avoided per transaction based on purchase of a product or service with less carbon emission than the predefined category of product or service with higher carbon emission, wherein carbon emissions are computed based on a predefined emission factor of the predefined category of product or service classified by the classification module. The processing subsystem further includes an environmental footprint computation module configured to compute environment footprints per transaction using a machine learning model trained based on the classification of the financial transaction data into a predefined category of product and service and the rate of emission avoided per transaction computed by the emission computation module. The environmental footprints computation module is also configured to compute environmental footprints corresponding to the individual by aggregating environmental footprints per transactions associated with the individual. The environmental footprints computation module is further configured to compute environmental footprints corresponding to the organization by aggregating environmental footprints per transaction associated with the organization. The processing subsystem further includes a score computation module configured to compute an environmental score associated with the organization based on the predefined emission factor as a function of a rank of the organization and the environmental footprints computed by the environmental footprint computation module. The score computation module is also configured to compute an environment score associated with the individual using a profile information to adapt estimation of the emission factor using a plurality of criterion impacting the rate of emission and the environmental footprints computed by the environmental footprints computation module.

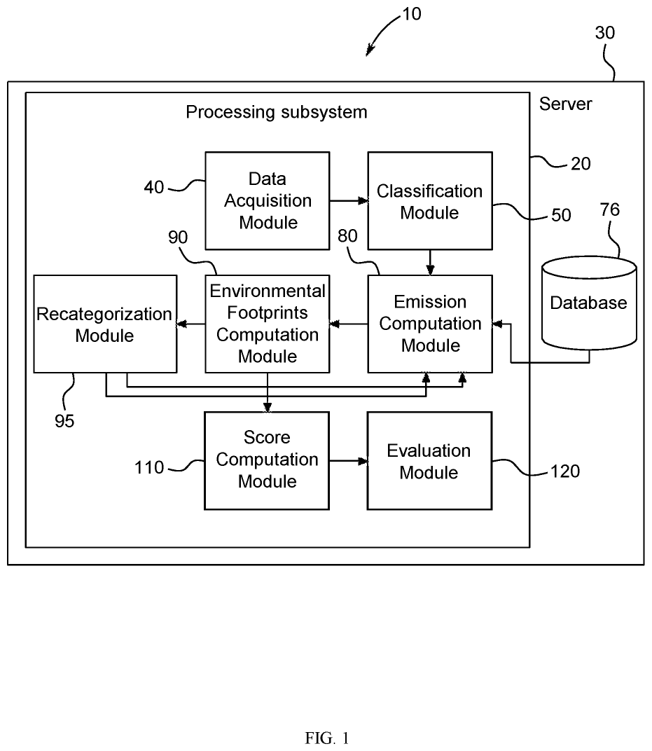

FIG. 1 is a block diagram representation of system 10 to determine environmental emission and footprints in accordance with an embodiment of the present disclosure. The system 10 includes a processing subsystem 20 hosted on a server 30. In one embodiment, the server 30 may include a cloud server. In another embodiment, the server 30 may include a local server. the processing subsystem 20 is configured to execute on a network (not shown in FIG. 1) to control bidirectional communications among a plurality of modules. In one embodiment, the network may include a wired network such as local area network (LAN). In another embodiment, the network may include a wireless network such as wi-fi, Bluetooth, Zigbee, near field communication (NFC), infra-red communication (RFID) or the like. The processing subsystem 20 includes a data acquisition module 40 which is configured to acquire financial transaction data associated with an individual or an organization through a financial institution based software. As used herein, the financial transaction data is a data corresponding to each transaction performed by an individual or an organization for example purchase of food or daily usage products, transaction for transportation or the like. In a specific embodiment, the financial institution based software may include a bank application or an enterprises resource planning software.

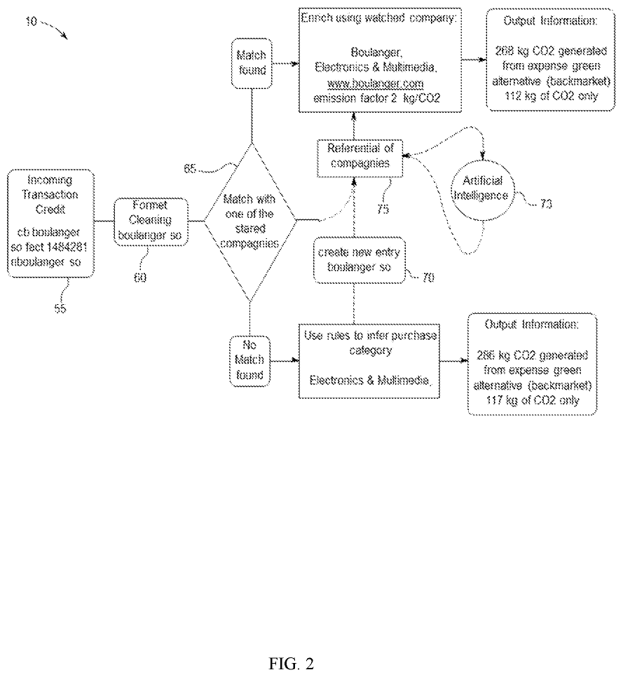

Furthermore, the processing subsystem includes a classification module 50 which is configured to label the financial transaction data and further sublevel it to classify into plurality of categories of services and products. In a specific embodiment, the classification module may be configured to categorize the financial data acquired by the data acquisition module within a predefined category of product and service by performing format cleaning, matching with stored providers, inferring purchase category, creation of new entry and process referential of organizations. More specifically, after synchronization with the secured server, financial data is acquired and stored in the form of copies of bank transactions. Each bank transaction data 55 is then classified into a purchase category and a company, if a successful match is found. As shown in FIG. 2, the first step of the categorization includes format cleaning 60 which cleans the acquired financial data. Further the data is matched 65 with one of the stored compagnies. If a match is not found, the system uses a set of rules to infer a purchase category. If a match is found, the system infers purchase category and creates a new entry 70, where the artificial intelligence technique 73 processes the referential of compagnies 75 by normalization, verification through external information, matching algorithms and collaborative update from community of users.

Referring to FIG. 1, the system includes a database 76 which is configured to store a predefined emission factor. In one embodiment, the predefined emission factor is obtained from public information or computed based on aggregated information over revenues. As used herein, the emission factor is the sum of emissions of CO2 equivalent resulting from the human activity described as mass unit of CO2 equivalent/reference flows. The processing subsystem further includes an emission computation module 80 which is configured to compute a rate of emission avoided per transaction based on purchase of a product or service with less carbon emission than the predefined category of product or service with higher carbon emission. The carbon emissions are computed based on the predefined emission factor of the predefined category of product or service classified by the classification module, where the predefined emission factor is stored in the database. Furthermore, the processing subsystem includes an environmental footprints computation module 90 which is configured to compute environment footprints per transaction using a machine learning model trained based on the classification of the financial transaction data into a predefined category of product and service and the rate of emission avoided per transaction computed by the emission computation module. As used herein, environmental footprints are carbon footprint, which means the amount of greenhouse gases, primarily carbon dioxide, released into the atmosphere by a particular human activity. In one embodiment, the environmental footprints are expressed in kilograms of carbon dioxide (CO₂) equivalent for every amount of currency spent.

In a case where environmental footprint calculation is affected due to the incorrect labelling and sub-labelling, a human in the loop and the artificial intelligence model is able to correct the classification (categorization into types of expenses) to improve the accuracy of the carbon footprint estimation by correcting possible mistakes and adding elements that could not be obtained from the transaction labels (for example, types of food, origin of the product, possible eco labels and so on). Based on these human inputs, an artificial intelligence algorithm learns to further improve the model. The processing subsystem includes a recategorization module 95 which is configured to articulate the labels with the user profile. More specifically, the recategorization module articulates the merchant labeling with the user profile labeling in order to classify accurately.

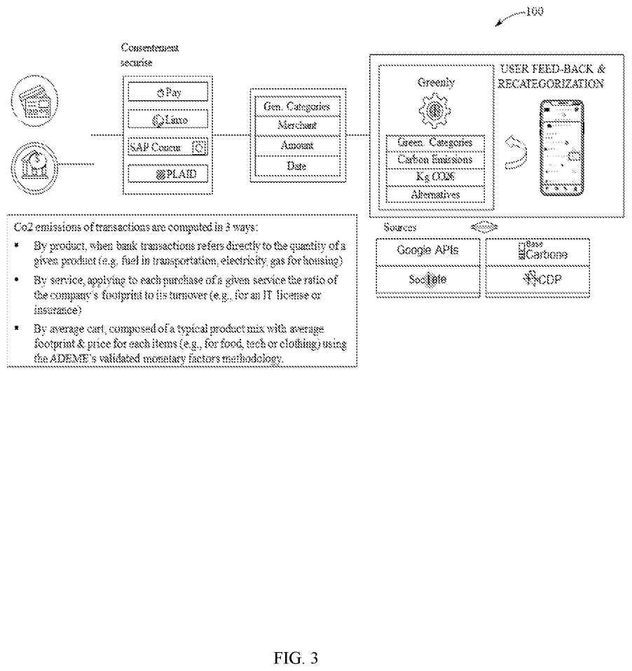

In a situation where calculations and evaluations are performed at individual level or the organization level, the recategorization module 95 classifies the financial transaction data corresponding to the individual or the organization into a plurality of categories of services and products associated with the predefined emission factor. More specifically, the recategorization module classifies the expenses into categories of services and products associated with given carbon emission factors and/or with given kinds of specific services for which a given emission factor is known, or/and with a given company. In one embodiment, the plurality of categories of services and products may use one or more word patterns enabling to recognize the organization with a satisfying level of certainty. In such an embodiment, the plurality of categories of services and products comprises looking for extra information publicly available to enrich the incoming transaction to be classified. In some embodiments, the recategorization module 95 may be configured to provide collective intelligence of the individual or the organization through acquisition and exploitation of re-labelling performed by a user to improve the classification and assign corresponding category of service and product. In such an embodiment, the recategorization module 95 may be configured to leverage user's collective intelligence through the acquisition and exploitation of relabeling done by the users using an online application running on a mobile device or computer, so as to improve the classification of an expense, and assigning the relevant category of service and products, or specific kind of business or company. As shown in FIG. 3, the CO2 emission of transactions are computed in three ways 100 such as by product, when bank transaction refers directly to the quantity of a given product (for example, fuel in transportation, electricity and gas for housing), by service, applying to each purchase of a given service the ratio of the company's footprints to its turnover (for example: an IT license or insurance) and by average cart, composed of a typical product mix with average footprint and price for each item (for example, food, tech or clothing) using the ADEME's validated monetary factors methodology.

Referring back to FIG. 1, at the individual or organization level, the emission computation module 80 which is configured to compute an emission factor corresponding to the organization based on carbon emission obtained from the individual or the organization over revenue and the environmental footprint computed by the environmental footprint computation module. It refers to the creation and the use of a referential of companies for which a specific emissions factor has been computed for each specific company whenever possible, using public information disclosed by the company, in particular through the publication of extra-financial activity reports. The emission computation module 80 calculates the emission factor at company level from the different carbon emissions (scope 1, 2 and 3 as classified under the Green House Gas Protocol) over revenues. As used herein, Scope 1 covers direct emissions from owned or controlled sources. Scope 2 covers indirect emissions from the generation of purchased electricity, steam, heating and cooling consumed by the reporting company. Scope 3 includes all other indirect emissions that occur in a company's value chain.

Moreover, at individual or organization level, the aggregated rate of emission avoided by the individual or the organization is computed by the emission computation module based on purchase of a product or service with less carbon emission than the predefined category of product or service with higher carbon emission. The carbon emissions are computed based on the emission factor of the predefined category of product or service purchased by the individual or the organization. In one embodiment, the emission computation module 80 may be configured to calculate emissions avoided by an individual or a corporation through the purchase of a given product or service, emitting comparatively less than what would have been emitted through the purchase of an equivalent category of product or service, whose emissions are computed using the given category's emissions factor.

Subsequently, the carbon footprint can be a broad measure or be applied to the actions of an individual, a family, an event, an organization, or even an entire nation. At the individual level or the organization level, the environmental footprint computation module 90 is configured to compute environmental footprints corresponding to the individual by aggregating environmental footprints per transactions associated with the individual. Similarly, compute environmental footprints corresponding to the organization by aggregating environmental footprints per transactions associated with the organization.

In addition, the processing subsystem 20 further includes a score computation module 110 which is configured to compute an environmental score associated with the organization based on the corresponding emission factor as a function of a rank of the organization and the environmental footprints computed for transactions. The score computation module 110 is also configured to compute an environmental score associated with the individual using a profile information so as to adapt the estimation of the emission factor using a plurality of criterion impacting the rate of emission and the environmental footprints computed for transaction. In one embodiment, the profile information may include at least one of eating habit, recycling practice, transportation mode, family size, housing or a combination thereof. The environment score is dependent on the relative position compared to other individuals, on a scale of total emissions over a given period of time, with total emissions themselves computed as a sum of the emissions of the person's purchases over that same period of time.

The processing subsystem 20 further includes an evaluation module 120 which is configured to perform qualitative evaluation of an ecological value of the individual or the organization based on the environmental score generated by the score generation module, the emission factor computed by the emission computation module and the environmental footprints computed by the environmental footprint computation module using a set of artificial intelligence techniques. In a specific embodiment, the qualitative evaluation relies on perception by the user on the consideration of the objectives of reduction of carbon dioxide (CO2) emissions by the individual. In such an embodiment, the qualitative evaluation is stored on the server and processed collectively by a collaborative filtering method from the set of artificial intelligence techniques to provide output corresponding to valuable and reliable evaluation. More specifically, the qualitative evaluation can be done by each user using an online application running on a mobile device or computer from his personal experience or personal evaluation of the company or shop and can be for example characterized by a number of stars out of a maximum of 5 stars. This evaluation relies for example on, but is not limited to, the perception by the user on the consideration of the objectives of reduction of CO2 emissions by the shop owner. This evaluation is then stored on the application server and processed collectively by an algorithm relying on methods from the field of artificial intelligence such as collaborative filtering to offer as output a valuable and reliable evaluation that can be used by less informed users of the application.

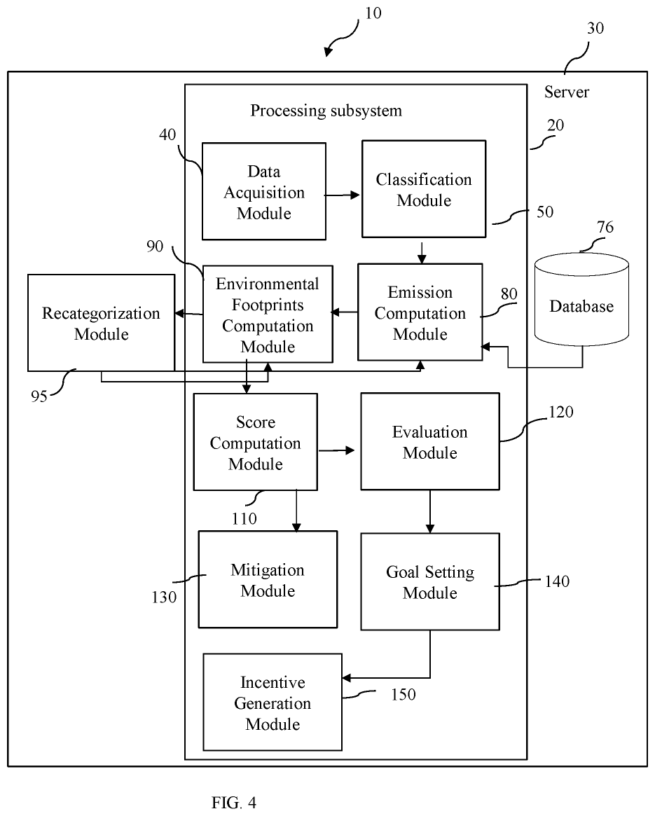

FIG. 4 is a block diagram representation of one embodiment of the system 10 of FIG. 1 in accordance with an embodiment of the present disclosure. The processing subsystem 20 of FIG. 1 includes a data acquisition module 40, a classification module 50, an emission computation module 80, an environmental footprint computation module 90, a score computation module 110, an evaluation module 120 and recategorization module 95. In one embodiment, the processing subsystem 20 of FIG. 1 also includes a mitigation module 130 which is configured to generate suggestions for one or more environmental footprint mitigation measures upon detecting purchases from the financial data to recommend purchases offering product or service having lower environmental footprints. In a specific embodiment, the processing subsystem 20 of FIG. 1 further includes a goal setting module 140 configured to enable the user to set one or more goals to neutralize the rate of emission for a predetermined period of time. The goal setting module 140 is also configured to enable the user to share the one or more goals with other users. In some embodiments, the processing subsystem 20 of FIG. 1 includes an incentive generation module 150 configured to provide incentives to the user based on the purchase of products or services with less carbon emissions.

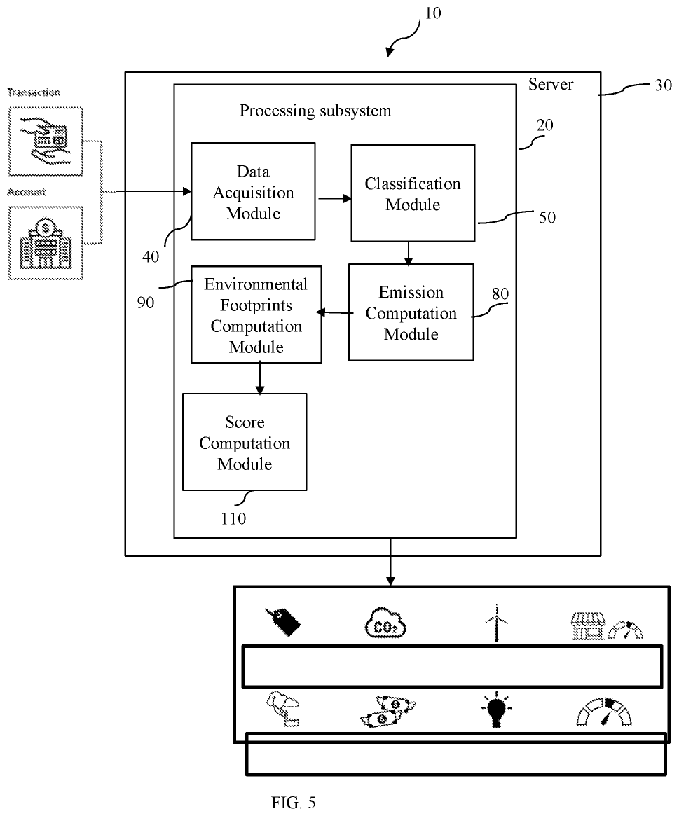

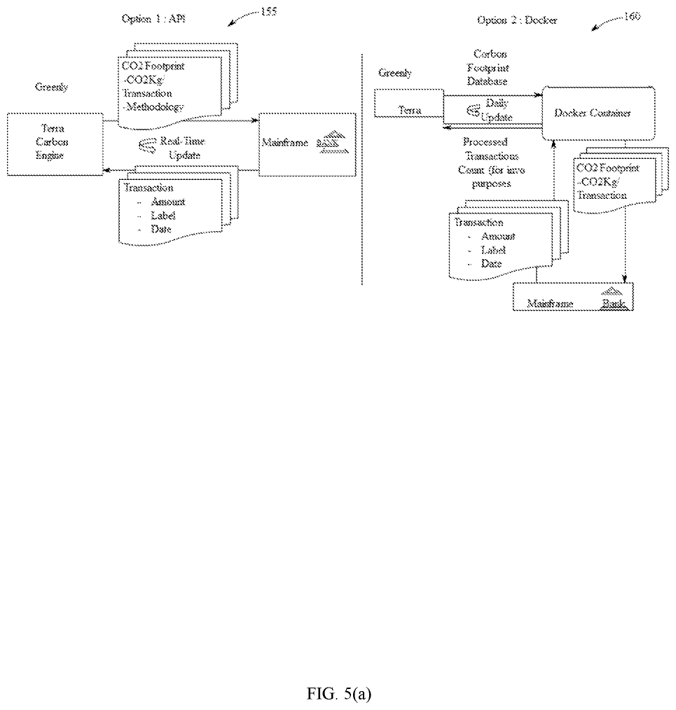

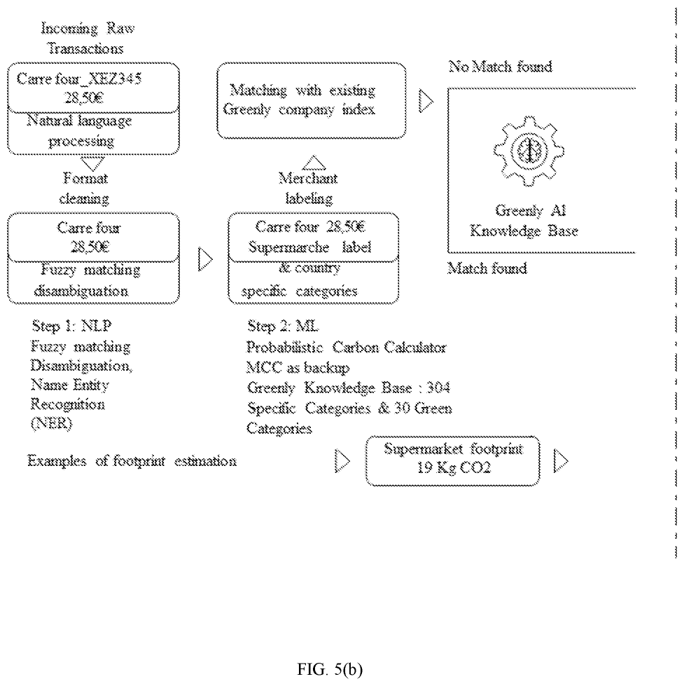

FIG. 5 is a schematic representation of an exemplary system 10 of FIG. 1 in accordance with an embodiment of the present disclosure. The system 10 is installed in a user device via an application programming interface (API) 155. In one embodiment, the user device may include a mobile phone, a computer, a tablet, a laptop, or the like. In one embodiment, the mainframe of the user device is directly plugged to the API for real-time carbon analytics, where the system continuously updates emissions ratio by category, merchants and brands. In another embodiment, a docker 160 associated with the system is updated on a daily basis to deploy terrabase directly within a banking environment, where transactions never leave bank's environment, for optimum security as shown in FIG. 5(a).

Considering an example where a user has performed a payment to the supermarket 165 and the user has asked his bank to transmit his information to the system via a banking software so that the transaction's information is fed to the algorithm to evaluate the environmental footprints. The classification module 50 performs format cleaning on the raw transaction data, fuzzy matching disambiguation, name entity recognition. Further, the environment footprint computation module 90 computes the environmental footprint of every purchase based on financial data, by automatically categorizing every transaction within a specific category of product and services, and computing relevant emission factors, expressed in kg of CO2 equivalent for every amount of currency spent. The environment footprint computation module 50 matches with existing company index in an AI knowledge base. If match is not found, the system uses a set of rules to infer the purchase category. If the match is found, the system infers the purchase category and creates a new entry, where the artificial intelligence technique processes the referential of companies by normalization, verification through external information, match algorithms and collaborative update from the community of users. For example, as shown in FIG. 5(b), the carbon footprint of a particular payment made at the supermarket is 19 KG of CO2 equivalent, but this would be for a single particular expense in a single particular supermarket. The supermarket purchase category has an emission coefficient that is calculated in terms of kgs of CO2 per euro, while a particular supermarket could have his own emission coefficient in terms of kgs of CO2 per euro spent at this particular supermarket. These information on supermarkets or a particular supermarket would then be stored in the database and would be used as information to compute the carbon footprints of clients feeding their expenses into the system.

The emission computation module 80 computes a rate of emission avoided by the individual or the organization based on the purchase of a product or service with less carbon emission than the predefined category of product or service with higher carbon emission. The carbon emissions are computed based on the emission factor of the predefined category of product or service purchased by the individual or the organization.

The score computation subsystem 110 computes an environment score associated with the individual using a profile information, thus enabling an finer tailoring of the emission factor using a plurality of criteria impacting the rate of emission and the environmental footprint computed for the payment performed at the supermarket. For example, the carbon footprint of a transaction is modified through the information obtained from the system. If the provider is “Carrefour”, the emission coefficient used corresponds to “Carrefour” and hence the carbon footprint of the payment is equal to 21 Kgs, while it is different if it is another merchant with an eco-friendlier sourcing policy, such as “Naturalia”, a more environmentally aware company, which would hence reduce the carbon footprint of that particular expense to 16 Kg CO2, where the average diet is computed as 15.5 Kg CO2 for the user. Additionally, adding information also allows to correct and/or adapt the carbon footprint estimation.

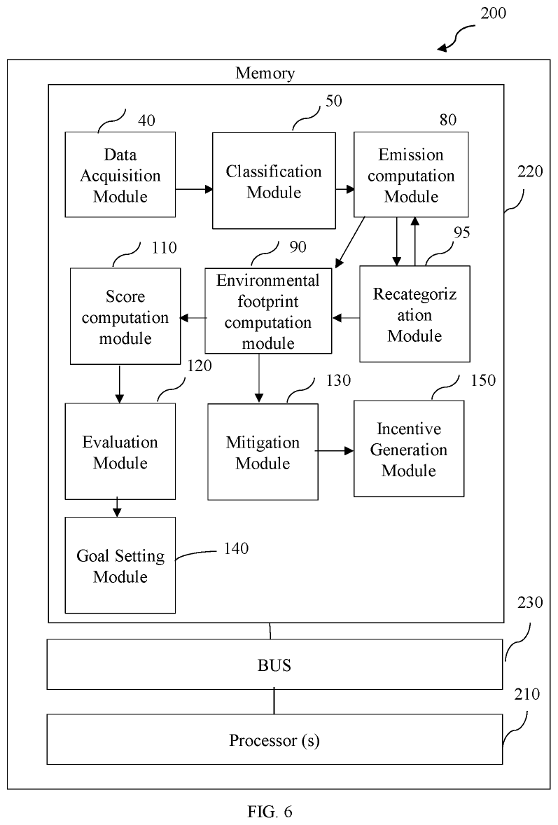

FIG. 6 is a block diagram of a computer or a server 200 for a system to determine environmental emission and footprints in accordance with an embodiment of the present disclosure. The server includes processor(s) 210, and memory 220 operatively coupled to the bus 230.

The processor(s) 210, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 220 includes a plurality of subsystems and a plurality of modules stored in the form of an executable program which instructs the processor 210 to perform the method steps illustrated in FIG. 1. The memory 220 is substantially similar to the system 10 of FIG. 1. The memory 220 has following subsystems: a processing subsystem 20 including a data acquisition module 40, a classification module 50, an emission computation module 80, an environmental footprint computation module 90, a score computation module 110, an evaluation module 120, a recategorization module 95, a mitigation module 130, a goal setting module 140 and an incentive generation module 150.

The processing subsystem includes a data acquisition module configured to acquire financial transaction data associated with an individual or an organization through a financial institution based software. The processing subsystem also includes a classification module configured to classify the financial transaction data acquired by the data acquisition module by labelling and sub-labelling into a plurality of categories of services and products. The processing subsystem includes an emission computation module configured to compute a rate of emission avoided per transaction based on purchase of a product or service with less carbon emission than the predefined category of product or service with higher carbon emission, wherein carbon emissions are computed based on a predefined emission factor of the predefined category of product or service classified by the classification module. The processing subsystem further includes an environmental footprint computation module configured to compute environment footprints per transaction using a machine learning model trained based on the classification of the financial transaction data into a predefined category of product and service and the rate of emission avoided per transaction computed by the emission computation module. The environmental footprints computation module is also configured to compute environmental footprints corresponding to the individual by aggregating environmental footprints per transactions associated with the individual. The environmental footprints computation module is further configured to compute environmental footprints corresponding to the organization by aggregating environmental footprints per transactions associated with the organization. The processing subsystem further includes a score computation module configured to compute an environmental score associated with the organization based on the predefined emission factor as a function of a rank of the organization and the environmental footprints computed by the environmental footprint computation module. The score computation module is also configured to compute an environment score associated with the individual using a profile information to adapt estimation of the emission factor using a plurality of criterion impacting the rate of emission and the environmental footprints computed by the environmental footprints computation module.

The evaluation module configured to perform qualitative evaluation of an ecological value of the individual or the organization based on the environmental score generated by the score generation module, the emission factor computed by the emission computation module and the environmental footprints computed by the environmental footprint computation module using a set of artificial intelligence techniques. The processing subsystem also includes a mitigation module which is configured to generate suggestions for one or more environmental footprint mitigation measures upon detecting purchases from the financial data to recommend purchases offering product or service having lower environmental footprints. The processing subsystem further includes a goal setting module configured to enable the user to set one or more goals to neutralize the rate of emission for a predetermined period of time. The goal setting module is also configured to enable the user to share the one or more goals with other users. The processing subsystem includes an incentive generation module configured to provide incentives to the user based on the purchase of products or services with less carbon emissions.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) 210.

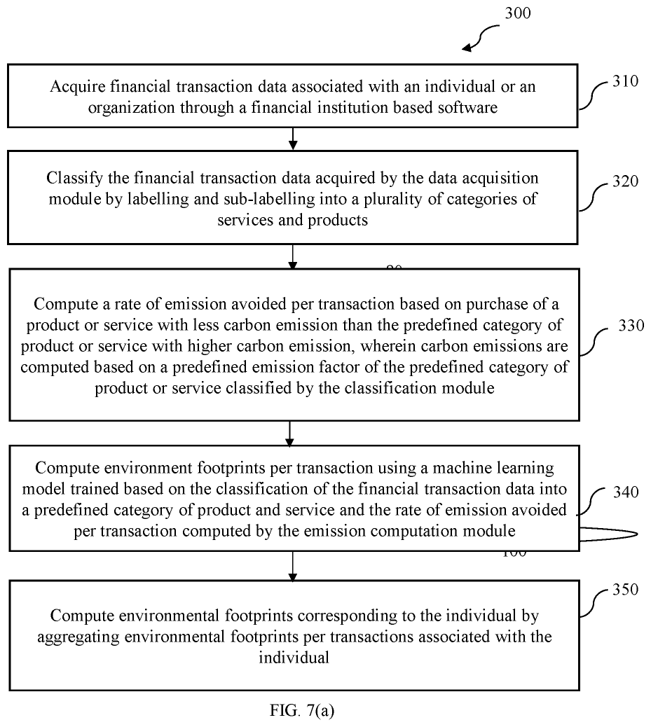

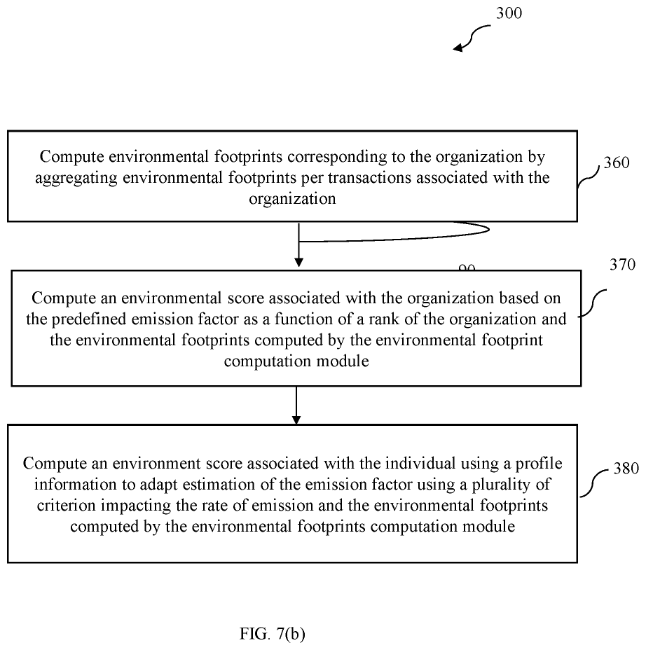

FIGS. 7(a) and 7(b) is a flow chart representing the steps involved in a method 300 to determine environmental emission and footprints based on financial data in accordance with an embodiment of the present disclosure. The method 300 includes acquiring financial transaction data associated with an individual or an organization through a financial institution based software in step 310. In one embodiment, acquiring financial data may include acquiring financial data by a data acquisition module. In a specific embodiment, the financial institution based software may include a bank application or an enterprises resource planning software. The method 300 also includes classifying the financial transaction data acquired by the data acquisition module by labelling and sub-labelling into a plurality of categories of services and products in step 320. In one embodiment, classifying the financial transaction data by labelling and sub-labelling into a plurality of categories of services and products may include classifying the financial transaction data acquired by the data acquisition module by labelling and sub-labelling into a plurality of categories of services and products by the classification module. In a specific embodiment, the classification computation module is configured to categorize the financial data acquired by the data acquisition module within a predefined category of product and service by performing format cleaning, matching with stored providers, inferring purchase category, creation of new entry and process referential of organizations.

Furthermore, the method 300 includes computing a rate of emission avoided per transaction based on purchase of a product or service with less carbon emission than the predefined category of product or service with higher carbon emission in step 330. The carbon emissions are computed based on a predefined emission factor of the predefined category of product or service classified by the classification module. In one embodiment, computing a rate of emission avoided per transaction based on purchase of a product or service may include computing a rate of emission avoided per transaction based on purchase of a product or service by the emission computation module.

Moreover, the method 300 includes computing environment footprints per transaction using a machine learning model trained based on the classification of the financial transaction data into a predefined category of product and service and the rate of emission avoided per transaction computed by the emission computation module in step 340. The method 300 also includes computing environmental footprints corresponding to the individual by aggregating environmental footprints per transaction associated with the individual in step 350. The method 300 also includes computing environmental footprints corresponding to the organization by aggregating environmental footprints per transactions associated with the organization in step 360. In one embodiment, computing environment footprints using a machine learning model trained based on the classification of the financial transaction data into a predefined category of product and service and the rate of emission avoided per transaction computed by the emission computation module may include computing environment footprints per transaction, environmental footprints corresponding to the individual and environmental footprints corresponding to the organization by an environmental footprint computation module. In a specific embodiment, the environmental footprints are expressed in kilograms of carbon dioxide (CO2) equivalent for every amount of currency spent.

Subsequently, the method 300 includes computing an environmental score associated with the organization based on the corresponding emission factor as a function of a rank of the organization and the environmental footprints computed by the environmental footprint computation module in step 370. In one embodiment, computing an environmental score associated with the organization may include computing an environmental score associated with the organization by a score computation module. The method 300 further includes computing an environment score associated with the individual using a profile information enables to adapt estimation of the emission factor using a plurality of criterion impacting the rate of emission and the environmental footprints computed by the environmental footprints computation module in step 380. In one embodiment, computing an environment score associated with the individual may include computing an environment score associated with the individual by the score computation module. In a specific embodiment, the profile information may include at least one of eating habit, recycling practice, transportation mode, family size, housing or a combination thereof. In some embodiments, the environmental score is dependent on a relative position compared to other individuals, on a scale of total emissions over a predefined period of time, with total emissions computed as a sum of the emissions of the individual's purchases over the predefined period of time.

Additionally, the method 300 includes performing qualitative evaluation of an ecological value of the individual or the organization based on the environmental score generated by the score generation module, the emission factor computed by the emission computation module and the environmental footprints computed by the environmental footprint computation module using a set of artificial intelligence techniques. In one embodiment, performing qualitative evaluation of an ecological value of the individual or the organization may include performing qualitative evaluation of an ecological value of the individual or the organization by an evaluation module. In a specific embodiment, the qualitative evaluation relies on perception by the user on the consideration of the objectives of reduction of carbon dioxide (CO2) emissions by the individual. In such an embodiment, the qualitative evaluation is stored on the server and processed collectively by a collaborative filtering method from the set of artificial intelligence techniques to provide output corresponding to valuable and reliable evaluation.

In one embodiment, the method 300 may include generating suggestion for one or more environmental footprint mitigation measures upon detecting purchases from the financial data to recommend purchases offering product or service having lower environmental footprints. In such an embodiment, generating suggestion for one or more environmental footprint mitigation may include generating suggestion for one or more environmental footprint mitigation by a mitigation module. In a specific embodiment, enabling the user to set one or more goals to neutralize the rate of emission for a predetermined period of time and share the one or more goals with other users. In such an embodiment, enabling the user to set one or more goals may include enabling the user to set one or more goals by a goal setting module. In some embodiments, the method 300 may include providing incentives to the user based on the purchase of products or services with less carbon emissions. In such an embodiment, providing incentives to the user may include providing incentives to the user by an incentive generation module.

Various embodiments of the system and method to determine environmental emission and footprints based on financial data as described above enables programmatic access of external financial service systems using an online application and calculating carbon footprint. An application proxy instance is created that simulates an application of an external financial service system. A normalized account request is received for financial data of the external financial service system for a specified account. The normalized account request is provided by an external financial application system by using a financial data API of the financial platform system. Responsive to the normalized account request, communication is negotiated with the external financial service system by using the application proxy instance to access the requested financial data from the external financial service system by using a proprietary Application Programming Interface (API) of the external financial service system.

The financial data is provided to the external financial application system as a response to the normalized account request. The financial data is categorized according to categories with homogeneous carbon footprint. Monetary emissions factors are attributed by spending category. Amount of transaction is converted into estimated greenhouse gas emissions quantities. An individual's emissions are estimated according to aggregated spending.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to determine environmental emissions and footprints based on financial data comprising:
a processing subsystem hosted on a server and configured to execute on a network to control bidirectional communications among a plurality of modules comprising:
a data acquisition module configured to acquire financial transaction data associated with an individual or an organization through a financial institution based software;
a classification module configured to classify the financial transaction data acquired by the data acquisition module by labelling and sub-labelling into a plurality of categories of services and products;
an emission computation module configured to compute a rate of emission avoided per transaction based on purchase of a product or service with less carbon emission than the predefined category of product or service with higher carbon emission, wherein carbon emissions are computed based on a predefined emission factor of the predefined category of product or service classified by the classification module;
an environmental footprint computation module configured to:
compute environment footprint per transaction using a machine learning model trained based on the classification of the financial transaction data into a predefined category of product and service and the rate of emission avoided per transaction computed by the emission computation module;
compute environmental footprint corresponding to the individual by aggregating environmental footprints per transaction associated with the individual;
compute environmental footprint corresponding to the organization by aggregating environmental footprints per transaction associated with the organization;
a score computation module configured to:
compute an environmental score associated with the organization based on the predefined emission factor as a function of a rank of the organization and the environmental footprint computed by the environmental footprint computation module; and
compute an environment score associated with the individual using a profile information to adapt estimation of the emission factor using a plurality of criterion impacting the rate of emission and the environmental footprint computed by the environmental footprints computation module.

2. The system of claim 1, wherein the financial institution based software comprises a bank application or an enterprises resource planning software.

3. The system of claim 1, wherein the environmental footprints are expressed in kilogram of carbon dioxide (CO2) equivalent for every amount of currency spent.

4. The system of claim 1, wherein the environmental footprint computation module is configured to categorize the financial data acquired by the data acquisition module within a predefined category of product and service by performing format cleaning, matching with stored providers, inferring purchase category, creation of new entry and process referential of organizations.

5. The system of claim 1, wherein the plurality of categories of services and products comprises use of one or more word patterns enabling to recognize the organization with a satisfying level of certainty.

6. The system of claim 1, wherein the plurality of categories of services and products comprises looking for extra information publicly available to enrich transaction received for classification.

7. The system of claim 1, wherein the classification module is configured to provide collective intelligence of the individual or the organization through acquisition and exploitation of re-labelling performed by a user to improve the classification and assign corresponding category of service and product.

8. The system of claim 1, wherein the profile information of user or transaction of an owner comprises at least one of eating habit, recycling practice, transportation mode, family size, housing or a combination thereof.

9. The system of claim 1, wherein an emission computation module configured to obtain the predefined emission factor from public information or compute the predefined emission factor based on aggregated information over revenues.

10. The system of claim 1, wherein the environmental score is dependent on a relative position compared to other individuals, on a scale of total emissions over a predefined period of time, with total emissions computed as a sum of the emissions of the individual's purchases over the predefined period of time.

11. The system of claim 1, wherein the processing subsystem comprises a mitigation module configured to generate suggestion for one or more environmental footprint mitigation measures upon detecting purchases from the financial data to recommend purchases offering product or service having lower environmental footprints.

12. The system of claim 1, wherein the processing subsystem comprises an evaluation module configured to perform qualitative evaluation of an ecological value of the individual or the organization based on the environmental score generated by the score generation module, the emission factor computed by the emission computation module and the environmental footprints computed by the environmental footprint computation module using a set of artificial intelligence techniques.

13. The system of claim 1, wherein the qualitative evaluation is stored on the server and processed collectively by a collaborative filtering method from the set of artificial intelligence techniques to provide output corresponding to valuable and reliable evaluation.

14. The system of claim 1, wherein the processing subsystem comprises a goal setting module configured to:
enable the user to set one or more goals to cap or neutralize the rate of emission for a predetermined period of time;
enable the user to share the one or more goals with other users.

15. The system of claim 1, wherein the processing subsystem comprises an incentive generation module configured to provide incentives to the user based on the purchase of products or services with less carbon emissions.

16. A method comprising:
acquiring, by a data acquisition module, financial transaction data associated with an individual or an organization through a financial institution based software;
classifying, by a classification module, the financial transaction data acquired by the data acquisition module by labelling and sub-labelling into a plurality of categories of services and products;
computing, by an emission computation module, a rate of emission avoided per transaction based on purchase of a product or service with less carbon emission than the predefined category of product or service with higher carbon emission, wherein carbon emissions are computed based on a predefined emission factor of the predefined category of product or service classified by the classification module;
computing, by an environmental footprints computation module, environment footprints per transaction using a machine learning model trained based on the classification of the financial transaction data into a predefined category of product and service and the rate of emission avoided per transaction computed by the emission computation module;
computing, by the environmental footprint computation module, environmental footprints corresponding to the individual by aggregating environmental footprints per transactions associated with the individual;
computing, by the environmental footprint computation module, environmental footprints corresponding to the organization by aggregating environmental footprints per transactions associated with the organization;
computing, by a score computation module, an environmental score associated with the organization based on the predefined emission factor as a function of a rank of the organization and the environmental footprints computed by the environmental footprint computation module; and
computing, by the score computation module, an environment score associated with the individual using a profile information to adapt estimation of the predefined emission factor using a plurality of criterion impacting the rate of emission and the environmental footprints computed by the environmental footprints computation module.

17. The method of claim 16, comprising providing, by the classification module, collective intelligence of the individual or the organization through acquisition and exploitation of re-labelling performed by a user to improve the classification and assign corresponding category of service and product.

18. The method of claim 16, comprising generating, by a mitigation module, suggestion for one or more environmental footprint mitigation measures upon detecting purchases from the financial data to recommend purchases offering product or service having lower environmental footprints.

19. The method of claim 16, comprising enabling, by a goal setting module, the user to set one or more goals to cap or neutralize the rate of emission for a predetermined period of time and share the one or more goals with other users.

20. The method of claim 16, comprising providing, by an incentive generation module, incentives to the user based on the purchase of products or services with less carbon emissions.
